(19) United States
(12) Patent Application Publication
(10) Pub. No.: US 2005/0232661 A1
(43) Pub. Date: Oct. 20, 2005

(54) Magnet roller

(76) Inventor: Hiroshi Murata, Komae City, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/513,987

(22) PCT Filed: May 8, 2003
(86) PCT No.: PCT/JP03/05759

§ 371 Date: May 27, 2005

(30) Foreign Application Priority Data
May 16, 2002 (JP) 2002-141339

(51) Int. Cl. G03G 15/09

(52) U.S. Cl. 399/277

(57) ABSTRACT

There is provided a magnet roller in which surface magnetic forces of a magnet roller main body 2 at peripheral angles of magnetic force peaks in a magnetic force pattern formed on a virtual peripheral face corresponding to an outer peripheral face of a sleeve are made approximately equal and maximum and the radial distances from an axial center of the shaft portion to the outer peripheral face of the magnet roller main body at peripheral angles corresponding to the magnetic force peaks are made different in accordance with magnitudes of the peak magnetic forces of the magnetic force peaks in the magnetic force on the virtual peripheral face R0, whereby the sectional area of the magnet roller main body can be made small as compared with the conventional one and also the same magnetic force pattern as the conventional one can be formed on the surface of the sleeve.

### TECHNICAL FIELD

This invention relates to a magnet roller forming a magnetic force pattern on a surface of a sleeve of a developing roller in an electrophotographic apparatus or an electrostatic recording apparatus such as copying machine, printer, facsimile or the like.

### BACKGROUND ART

In the electrophotographic apparatus or the electrostatic recording apparatus such as copying machine, printer, facsimile or the like, as a developing system for visualizing an electrostatic latent image on a latent image supporting body such as a photosensitive drum or the like, there is known a developing method wherein a developing roller is comprised of a rotating sleeve and a magnet roller arranged at an inside thereof in a radial direction and made of a resin magnet or the like, and a toner carried on a surface of the sleeve is supplied to a surface of the latent image supporting body by such a jumping phenomenon that the toner is jumped onto the latent image supporting body by magnetic force characteristic of the magnet roller to thereby visualize a latent image.

FIG. 4 is a front view of the conventional magnet roller 51 used in such a developing method, and FIG. 5 is a side view thereof. The conventional magnet roller 51 comprises a magnet roller main body 52 and both shaft portions 53 pivoting a sleeve 54. The magnet roller main body 52 is shaped into substantially a true circle at its section for forming a desired magnetic force pattern having a plurality of magnetic force peaks on an outer surface SX1 of the sleeve 54 along a peripheral direction thereof, and constructed so that a surface magnetic force at a position on the outer peripheral face corresponding to each of the magnetic force peaks is rendered into a given value. Further, in order to obtain a given peripheral change of the surface magnetic force on the outer peripheral face of the magnet roller main body 52, magnetic powder constituting the magnet roller main body 52 is oriented into a given direction or magnetized in a given magnetization pattern in the formation of the magnet roller 51. In the conventional magnet roller 51 shown in FIG. 5, when a section of the magnet roller main body 52 is a circle having a radius of R1, a peripheral change of the surface magnetic force is formed on the outer peripheral face of the magnet roller main body 52 so as to form a magnetic force pattern having four magnetic force peaks N1, S1, N2, S2 on the surface SX1.

FIG. 6 shows a magnetic force pattern QS on the surface SX1 formed by the magnet roller 51 and a peripheral change QM of the surface magnetic force of the magnet roller 51 wherein a peripheral angle θ around an axial center of a shaft portion 53 of the magnet roller 51 is plotted on an abscissa and a magnetic flux F is plotted on an ordinate. Among the magnetic force peaks in the magnetic force pattern QS, a peak magnetic force of the magnetic force peak N1 is maximum and a peak magnetic force of the magnetic force peak N2 is minimum, and values thereof are represented by GSmax and GSmin, respectively. Also, the peripheral change QM of the surface magnetic force of the magnet roller 51 changes so as to be substantially proportional to the magnetic force pattern QS on the surface SX1, and among the surface magnetic forces in peak directions of the magnetic force peaks N1, S1, N2, S2 of the magnetic force pattern QS, the surface magnetic force corresponding to the magnetic force peak N1 shows a maximum one GMmax and the surface magnetic force corresponding to the magnetic force peak N2 shows a minimum one GMmin.

Recently, it is increasingly demanded to make the cost of the magnet roller low accompanied with the price-reduction of the electro-photographic apparatuses such as copying machine, printer, facsimile and the like. Since a ratio of a material cost of the magnet roller main body 52 occupied in the production cost of the magnet roller 51 is large, if a sectional area of the magnet roller main body 52 can be reduced, the magnet roller 51 can be produced cheaply. However, when the sectional form of the magnet roller main body 52 is changed, there is a problem that a desired magnetic force pattern QS can not be obtained.

In the light of the above problem, the invention is to provide a magnet roller in which the desired magnetic force pattern similar to the conventional one can be formed on the surface of the sleeve even when the sectional area of the magnet roller main body is made smaller than that of the conventional one.

### DISCLOSURE OF THE INVENTION

The invention is made for achieving the above object, and is a magnet roller comprising shaft portions and a columnar magnet roller main body forming a magnetic force pattern having plural magnetic force peaks on a virtual peripheral face around axial centers of the shaft portions and using the axial centers of these shaft portions as an axial center, in which
when a direction using the axial center of the shaft portion as an original point in a plane perpendicular to the axial center of the shaft portion is represented by a peripheral angle θ from a given standard direction and a direction corresponding to a magnetic force peak of the magnetic force pattern on a virtual peripheral face of a radius R0 defined by an equation (1) is a peak direction of this magnetic force peak and a distance from the axial center of the shaft portion at a direction of the peripheral angle θ to an outer peripheral face of a magnet roller main body in a radial direction is R(θ), at least one radial distance R(θ) among radial distances R(θ) in peak directions of the magnetic force peaks is different from another radial distance R(θ), and
when a maximum peak magnetic force among peak magnetic forces of the magnetic force peaks of the magnetic force pattern on the virtual peripheral face of radius R0 is GSmax and a minimum peak magnetic force is GSmin and a maximum value among values of peak directions of the magnetic force peaks in a surface magnetic force on the outer peripheral face of the magnet roller main body is GM max and a minimum value is GMmin, they satisfy an equation (2):
   Rmax<R<Rmax+3 (mm) (1)
   GMmax−GMmin<(GSmax−GSmin)/2 (2)
   provided that in the equation (1), Rmax is a maximum value of the radial distance R(θ) with respect to a peripheral angle θ of 0°-360°.

### BRIEF DESCRIPTION OF THE DRAWINGS

FIG. 1 is a front view of an embodiment of the magnet roller according to the invention.

FIG. 2 is a side view of the magnet roller.

FIG. 3 is a view showing a magnetic force pattern and a change of a surface magnetic force in the magnet roller.

FIG. 4 is a front view of an embodiment of the conventional magnet roller.

FIG. 5 is a side view of the conventional magnet roller.

FIG. 6 is a view showing a magnetic force pattern and a change of a surface magnetic force in the conventional magnet roller.

### BEST MODE FOR CARRYING OUT THE INVENTION

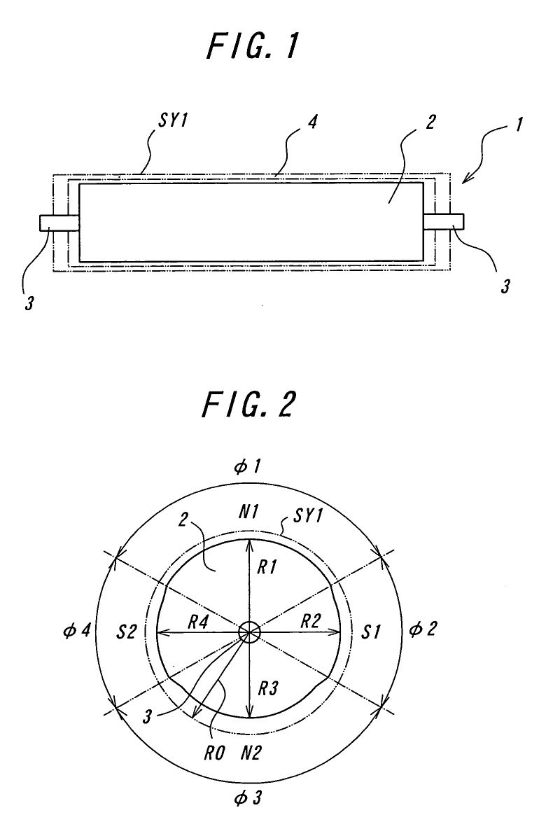

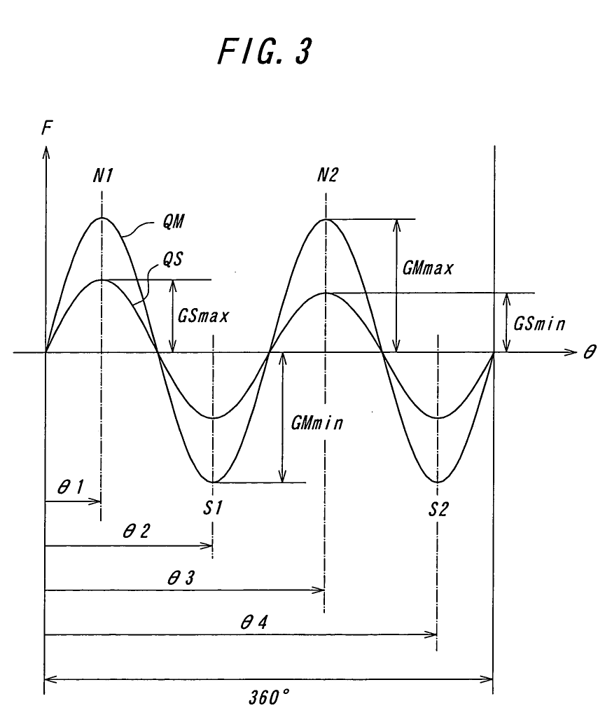

An embodiment of the invention will be described below with reference to FIGS. 1 and 3. FIG. 1 is a front view illustrating a magnet roller 1 according to this embodiment, and FIG. 2 is a side view thereof. The magnet roller 1 comprises a magnet roller main body 2 and two shaft portions 3 bearing a sleeve 4. The magnet roller main body 2 forms a desired magnetic force pattern having four magnetic force peaks N1, S1, N2, S2 shown in FIG. 2, which change in a peripheral direction on a virtual peripheral face SY1 of a radius R0 corresponding to an outer peripheral face of the sleeve 4 to be combined at a mounted state of the magnet roller.

FIG. 3 shows a magnetic force pattern QS in a peripheral direction formed by the magnet roller 1 on the virtual peripheral face SY1 and a change QM in the peripheral direction of a surface magnetic force of the magnet roller main body 2 of the magnet roller 1 in which a peripheral angle θ showing a direction around an axial center of the shaft portion in the magnet roller 1 is plotted on an abscissa and a magnetic flux density F is plotted on an ordinate. In the magnetic force pattern QS are existent four magnetic force peaks, i.e. a magnetic force peak N1 having a peak magnetic force at a direction of a peripheral angle θ1, a magnetic force peak S1 having a peak magnetic force at a direction of a peripheral angle θ2, a magnetic force peak N2 having a peak magnetic force at a direction of a peripheral angle θ3 and a magnetic force peak S2 having a peak magnetic force at a direction of a peripheral angle θ4. Among them, the magnetic force peak N1 shows a maximum peak magnetic force GSmax, and the magnetic force peak N2 shows a minimum peak magnetic force GSmin.

In the peripheral change QM of the surface magnetic force of the magnet roller main body 2, however, the magnitude of the surface magnetic force is approximately equal at peak directions of the peak magnetic forces, and when a maximum among four surface magnetic forces at the peak directions is GMmax and a minimum is GMmin, these magnetic forces satisfy a relation shown by the equation (2).

Moreover, the term “peak magnetic force” used herein is represented by an absolute value irrespective of the polarity of the magnetic force, and the term “peak direction” means a direction of an apex of the magnetic force peak in the magnetic force pattern formed on the virtual peripheral face SY1 around the axial center of the shaft portion.

Among the radial distances R1-R4 at the peak directions of the magnetic force peaks in the magnet roller 1 from the axial center of the shaft portion to the outer peripheral face of the magnet roller main body, at least one distance is different from the other ones. In the magnet roller of this embodiment, as the peak magnetic force of the magnetic force peak becomes high, the radial distance thereof becomes large. That is, among the radial distances R1-R4, the radial distance R1 corresponding to the magnetic force peak N1 showing the maximum peak magnetic force GSmax is maximum, and the radial distance R3 corresponding to the magnetic force peak N2 showing the minimum peak magnetic force GSmin is minimum.

In brief, in order to form the magnetic force peaks N1, S1, N2, S2 of the magnetic force pattern on the virtual peripheral face R0, in the conventional magnet roller 51, the radial distances from the axial center of the shaft portion to the outer peripheral face of the magnet roller main body 52 at the peak directions of the magnetic force peaks represented by the peripheral angles θ1-θ4 are made the same R1 to change the surface magnetic force of the magnet roller main body 52 at the peak directions of the magnetic force peaks. In the magnet roller 1 of the above embodiment, however, the surface magnetic forces of the magnet roller main body 2 at the peak directions of the magnetic force peaks are made approximately equal and maximum as far as possible, and the radial distances R1-R4 corresponding to the magnetic force peaks are made different in accordance with the peak magnetic forces of the magnetic force peaks N1, S1, N2, S2 of the magnetic force pattern on the virtual peripheral face R0, so that as symbolically exemplified by the magnetic force peak N2, the radial distance corresponding to the magnetic force peak, which should be made smaller than the other magnetic force peaks, can be largely reduced as compared with the conventional one, and hence the sectional area of the magnet roller main body 2 can be reduced as compared with the conventional one, which can contribute to the cost down of the magnet roller.

Moreover, the magnet roller 1 shown in the above embodiment has four magnetic force peaks at the peak directions in which the peripheral angle θ differs every 90 degrees, but the invention is not limited to this embodiment. The number of the magnetic force peaks may be values other than four, and also the difference of the peripheral angle θ between mutual magnetic force peaks may be freely selected. Even in these cases, the same effect as mentioned above can be obtained.

Furthermore, the magnet roller 1 according to this embodiment has a construction that the shaft portion 3 and the magnet roller main body 2 are integrally formed with a resin magnet of the same material. However, the shaft portion 3 may be formed separately from the magnet roller main body 2 as left and right independent metal shafts or a metal shaft passing through the magnet roller main body 2 in an axial direction thereof. Further, the magnet roller main body 2 may be made of a resin magnet or a sintered body. In addition to the one-piece body, pieces having a fan-shaped section can be used by sticking them to each other as the magnet roller main body 2. Even in these cases, the same effect as mentioned above can be obtained.

Since the magnetic force acting to toner on the sleeve 4 is preferable to be stronger, the outer diameter of the sleeve 4 is desirable to be made small within a range not interfering with the magnet roller 1 in the rotation outside the magnet roller 1. It is sufficient that the radius R0 of the virtual peripheral face SY1 is within the range defined by the equation (1) as a condition for achieving the object of the invention.

### EXAMPLE

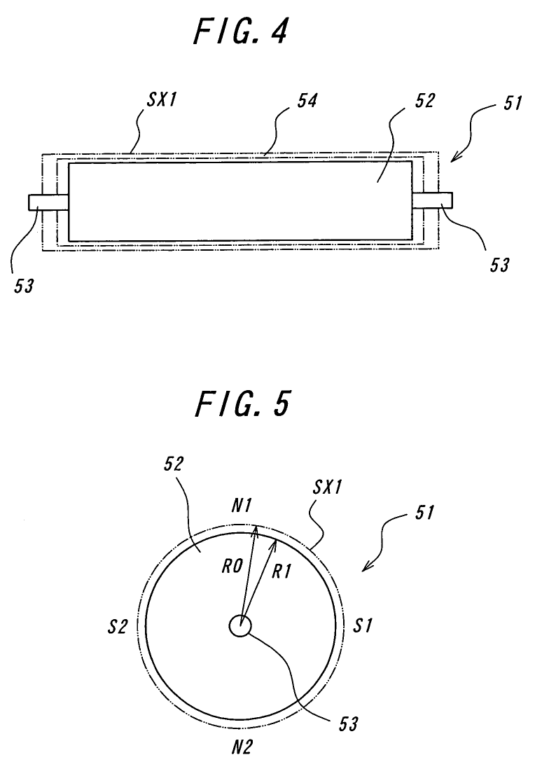

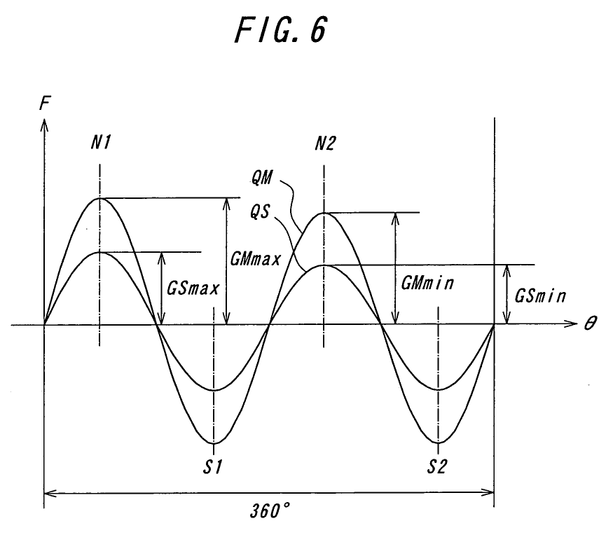

There are prepared a magnet roller 1 shown in FIGS. 1 and 2 as an example, and a magnet roller 51 shown in FIGS. 4 and 5 as a conventional example, respectively, to compare peak magnetic forces on a virtual periphery of 6 mm in radius formed by these magnet rollers and sectional areas of magnet roller main bodies thereof. In the magnet rollers of the example and the conventional example, the number of magnetic force peaks is 4 and the difference of peripheral angle between the adjoining magnetic force peaks is 90 degrees.

In Table 1 are shown results of the magnet rollers of the example and the conventional example measured on radial distances at peak directions of magnetic force peaks in a magnetic force pattern on the virtual periphery of 6 mm in radius, surface magnetic forces on outer peripheral face of the magnet roller main body at the peak directions of the magnetic force peaks, peak magnetic forces at the magnetic force peaks and sectional area of the magnet roller main body, respectively. In the magnet roller 1 of the example, a magnet roller portion corresponding to the magnetic force peak N1 is formed in the form of a fan having a radial distance R1 in which a central angle 41 thereof is 120 degrees, and also magnet roller portions corresponding to the other magnetic force peaks are formed in the form of fans in which central angles φ2-φ4 of the fans corresponding to the magnetic force peaks S1, N2 and S2 are 60 degrees, 120 degrees and 60 degrees in this order, respectively. Also, the adjoining fans differ in the radius from each other, so that they are smoothly joined so as not to cause a difference in level at an outer peripheral joined portion thereof.

In Table 1, the reduction ratio of sectional area is a ratio of reducing amount to the sectional area of the conventional example and represented by %. As seen from Table 1, the sectional area of the magnet roller main body 2 in the magnet roller 1 of the example can be reduced by 6% as compared with that of the conventional example, which can save a material cost of the magnet roller corresponding to the reduction of the sectional area and reduce the cost. Further, Table 1 shows that the peak magnetic forces of magnetic force peaks in the magnetic force pattern of the magnet roller of the example on the virtual peripheral face of 6 mm in radius can be made substantially equal to those of the conventional example. Moreover, calculated values of left side and right side of the equation (2) are described in a lower column of Table 1, from which it is apparent that the example satisfies the relation of the equation (2), but the conventional example does not satisfy the relation of the equation (2).

TABLE 1

| | | Conven- | |
|---|---|---|---|
| | Magnetic | tional | |
| | force peak | Example | Example |
| Radial distance (mm) | N1 | 5.0 | 5.0 |
| | S1 | 5.0 | 4.9 |
| | N2 | 5.0 | 4.6 |
| | S2 | 5.0 | 4.9 |
| Peak magnetic force (mT) | N1 | 75 | 74 |
| | S1 | 68 | 69 |
| | N2 | 61 | 60 |
| | S2 | 68 | 69 |
| Surface magnetic force (mT) | N1 | 128 | 136 |
| | S1 | 123 | 134 |
| | N2 | 115 | 137 |
| | S2 | 123 | 134 |
| Sectional area of magnet roller main | | 78.5 | 73.8 |
| body (mm²) | | | |
| Reduction ratio of sectional area (%) | | 0 | 6 |
| Left side of equation (2) (mT) | | 13 | 3 |
| Right side of equation (2) (mT) | | 7 | 7 |

### INDUSTRIAL APPLICABILITY

As seen from the above, according to the invention, the surface magnetic forces of the magnet roller main body 2 at the peak directions of the magnetic force peaks in the magnetic force pattern on the virtual peripheral face of a radius R0 defined by the equation (1) are formed so as to satisfy the equation (2), and also the radial distance R1-R4 corresponding to the magnetic force peaks are made different in accordance with the peak magnetic forces of these magnetic force peaks, so that the radial distance corresponding to the magnetic force peak having a small peak magnetic force can be reduced in the required magnetic force pattern as compared with the conventional one, and hence the sectional area of the magnet roller main body 2 can be decreased as compared with the conventional one, which can contribute the cost down of the magnet roller.

1. A magnet roller comprising shaft portions and a columnar magnet roller main body forming a magnetic force pattern having plural magnetic force peaks on a virtual peripheral face around axial centers of the shaft portions and using the axial centers of these shaft portions as an axial center, in which
when a direction using the axial center of the shaft portion as an original point in a plane perpendicular to the axial center of the shaft portion is represented by a peripheral angle θ from a given standard direction and a direction corresponding to a magnetic force peak of the magnetic force pattern on a virtual peripheral face of a radius R0 defined by an equation (1) is a peak direction of this magnetic force peak and a distance from the axial center of the shaft portion at a direction of the peripheral angle θ to an outer peripheral face of a magnet roller main body in a radial direction is R(θ), at least one radial distance R(θ) among radial distances R(θ) in peak directions of the magnetic force peaks is different from another radial distance R(θ), and
when a maximum peak magnetic force among peak magnetic forces of the magnetic force peaks of the magnetic force pattern on the virtual peripheral face of radius R0 is GSmax and a minimum peak magnetic force is GSmin and a maximum value among values of peak directions of the magnetic force peaks in a surface magnetic force on the outer peripheral face of the magnet roller main body is GM max and a minimum value is GMmin, they satisfy an equation (2):
Rmax<R<Rmax+3 (mm) (1)
GMmax−GMmin<(GSmax−GSmin)/2 (2)
provided that in the equation (1), Rmax is a maximum value of the radial distance R(θ) with respect to a peripheral angle θ of 0°-360°.
